(19) United States
(12) Patent Application Publication
(10) Pub. No.: US 2008/0029099 A1
(43) Pub. Date: Feb. 7, 2008

(54) VALVE BALLOON FOR INHALERS

(75) Inventor: Markus Storz, Tuttlingen (DE)

Correspondence Address: BACHMAN & LAPOINTE, P.C., 900 CHAPEL STREET, SUITE 1201, NEW HAVEN, CT, 06510, US

(73) Assignee: VAPORMED GMBH & CO. KG, Tuttlingen (DE)

(21) Appl. No.: 11/829,425

(22) Filed: Jul. 27, 2007

(30) Foreign Application Priority Data
Aug. 1, 2006 (EP) 06015945.6-2310

(51) Int. Cl. A62B 9/02

(52) U.S. Cl. 128/205.24

(57) ABSTRACT

The valve mechanism previously used for inhalation from a valve balloon is expensive, heavy and sensitive, and requires a lot of maintenance. With the new valve mechanism, which is principally composed of an elastic, slotted membrane, the membrane can be pushed open with a tube, and the valve balloon can be filled and then emptied again by a tube. The membrane closes automatically and, in cooperation with a mouthpiece, can push the latter back into its starting position. The balloon is secured within the valve housing by means of a clamping ring. This design permits inexpensive production of a complete valve balloon, including mouthpiece, which is suitable for one-off use, as is required, for hygiene reasons, in medical applications. Moreover, the new valve balloon is lighter and more robust than the previous models.

### BACKGROUND OF THE INVENTION

The present invention is basically a development of the patent held by the same author (DE 198 03 376, or EP 0933093, and U.S. Pat. No. 6,513,524). The removable valve balloon described in these documents allows the aerosol, containing aroma and active substance, to be inhaled completely independently of the aerosol-generating appliance. This permits completely safe inhalation, since the user is no longer connected to the usually electrically operated aerosol generator. In addition, the inhalation from the valve balloon is considerably more convenient, since it can in principle be done at any location and without having to take account of the technical demands of the aerosol generator. The valve balloon is suitable mainly, but not exclusively, for use in hot air extraction inhalers, so-called vaporizers, such as are also described, for example, in the patent held by the same author and entitled “Hot air production in hot air extraction inhalers” (DE 100 42 396). The reason for this lies in the very small droplet size of the aerosol produced in the thermal vaporization, compared with atomizers or nebulizers, as a consequence of which the condensation of the aerosol on the jacket of the balloon is delayed for a sufficiently long period of time.

### General Aspects of Hot Air Extraction:

In hot air extraction, medicinal herbs or other suitable plant materials are comminuted and then have air heated at a temperature of up to 235° C. passed through them, as a result of which the aromas and active substances contained in the materials “vaporize” and cross over into the hot air. This air, charged with aromas and active substances, is inhaled after it has been cooled to a comfortable temperature, and the active substances pass into the blood stream via the pulmonary alveoli. At temperatures above 235° C., the herbs would begin to burn, since the self-combustion point of cellulose and plant material would be exceeded.

With inhalers of this kind, active substances from suitable pharmaceuticals in liquid and powder form can also be vaporized and inhaled, in which process it is possible to use vaporization temperatures well above 235° C.

In hot air extraction, no water is heated in order to generate vapor. The vapors or aerosol are obtained solely by the effect of heat on the respective substances.

The valve mechanism described in patent DE 198 03 376 and in the meantime marketed in a slightly modified form (connection of valve to filling chamber or mouthpiece with releasable snap-fit hooks instead of screw thread), is expensive, heavy, and sensitive, and it is awkward to disassemble and clean. The balloon secured on the outside of the valve with rubber rings does not remain securely in place. Due to their medical conditions, some users are not able to assemble the valve parts and apply a new balloon. For reasons of hygiene in medical use, a valve balloon is needed that is as inexpensive as possible and that can be completely disposed of after use.

### SUMMARY OF THE INVENTION

The object of the invention is to make available a valve balloon, including mouthpiece, which is as cost-effective as possible and whose functionality is at least as good as that of the previous one.

According to the invention, this object is achieved by the features set forth herein (valve mechanism with an elastic, slotted membrane, and a balloon that can be locked by means of a clamping ring).

The advantages obtained by the invention are, in particular, that the production costs are hugely reduced compared to those of the previous valve mechanism. This in turn permits the disposable use that is needed for hygiene reasons. In addition, the new valve balloon is lighter and more robust, and it eliminates the need for awkward cleaning and the attachment of a new balloon.

An advantageous embodiment of the invention is that, in cooperation with a mouthpiece, the membrane pushes the latter back into its starting position during the closure process.

A further advantageous embodiment of the invention is that the membrane there is secured in the valve housing by means of a lockable clamping ring.

### BRIEF DESCRIPTION OF THE DRAWINGS

The invention is explained in more detail below on the basis of an illustrative embodiment depicted in the drawing, in which:

FIG. 1 shows a longitudinal section through the valve mechanism according to the invention, during filling of the valve balloon by means of a filling tube;

FIG. 2 shows a perspective view of a membrane, in the rest position, provided with a cross-shaped slot;

FIG. 3 shows a perspective view of a membrane that is provided with a cross-shaped slot, and that is in an opened state after a tube has been pushed through it;

FIG. 4 shows a longitudinal section through the valve mechanism according to the invention, during emptying of the valve balloon by means of a mouthpiece;

FIG. 5 shows a longitudinal section through the valve mechanism according to the invention in the closed state, with mouthpiece.

### DETAILED DESCRIPTION

The valve mechanism according to the invention, illustrated in FIG. 1, comprises a valve housing (2), the balloon (1) (partially shown), and the slotted membrane (3). The figure also shows the filling tube (4) through which the aerosol is pumped into the valve balloon. The filling tube (4) is pushed through the membrane (3), and the latter is therefore in the opened state. When the filling tube (4) is removed after the filling operation, the membrane (3) returns to its original flat state. It is then tightly closed and holds the aerosol in the balloon.

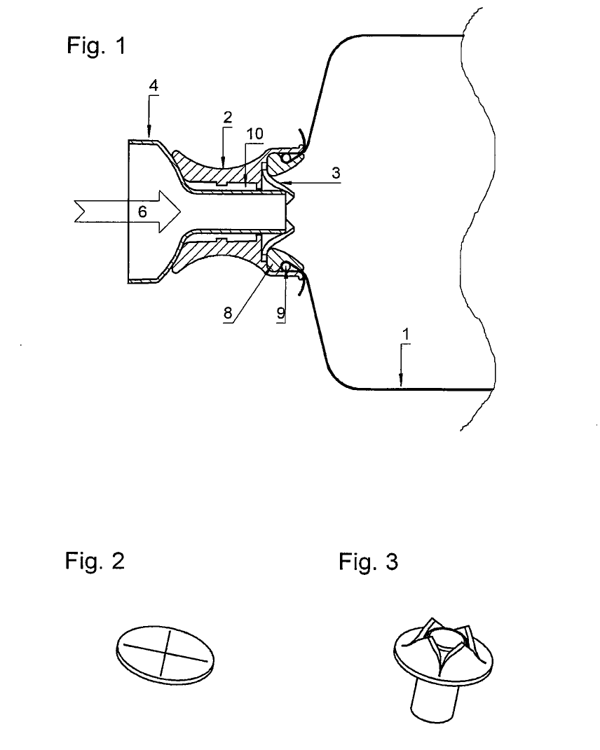

FIGS. 2 and 3 show an example of a membrane with a cross-shaped slot. However, it also functions with a single slot or with any desired number of slots that intersect at the center of the membrane.

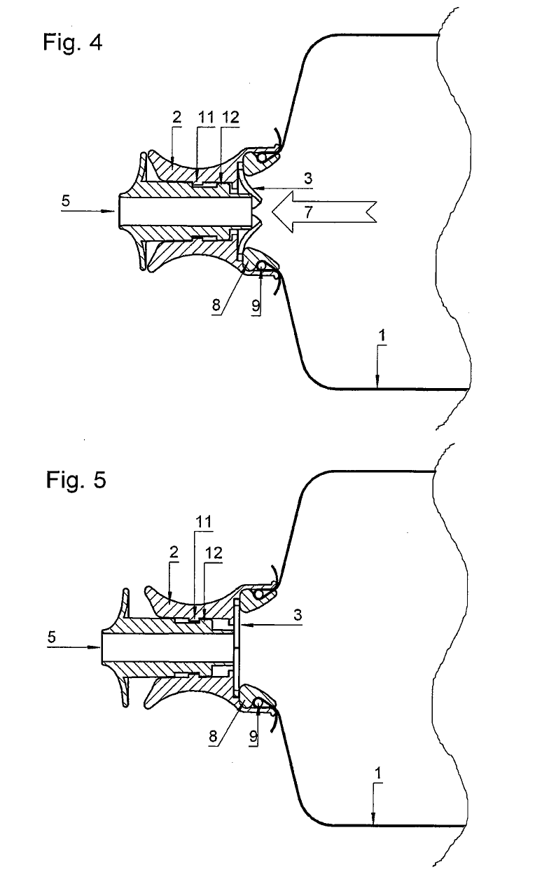

As is shown in FIG. 4, the mouthpiece (5), instead of the filling tube, has now been fitted in the valve housing (2). By pressing the lips onto the mouthpiece (5), the latter is moved toward the membrane (3), pushes through the latter and thus opens the valve, as shown. When the valve balloon with mouthpiece is removed from the lips, the membrane (3) automatically pushes the mouthpiece (5) back, and the valve is closed again, as is shown in FIG. 5.

The inventive means of arranging the balloon (1) on the valve housing (2), as shown in FIGS. 1, 4 and 5, comprises an elastic O-ring (9), which secures the balloon jacket (1) on a hard clamping ring (8). The protruding end of the balloon jacket (1) is preferably turned back around the O-ring (9) and then locked together with the clamping ring (8) into the valve housing (2). The soft O-ring (9) ensures that the balloon (1) is sealed off relative to the valve housing (2) and the clamping ring (8).

The valve housing (2) in this embodiment defines an inner passage 10 for interchangeably receiving a filling tube (4) (FIG. 1) or mouthpiece (5) (FIGS. 4 and 5).

Interlocking structure (11,12) can be on inner passage (10) and mouthpiece (5) to releasably hold mouthpiece (5) within inner passage (10). This structure further preferably defines a range of motion of mouthpiece (5) relative to valve housing (2), and allows mouthpiece (5) to be moved toward balloon (1) so as to extend through membrane (3) (FIG. 4) in an emptying process, and to be returned to a rest position (FIG. 5) wherein membrane (3) closes.

Interlocking structure (11,12) may be provided as a plurality of arms each having an inwardly extending structure, and as a narrow portion along mouthpiece (5) and a ridge or flange extending outwardly from the narrow portion.

While the present disclosure has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

### LIST OF REFERENCES NUMBERS

1 balloon
2 valve housing
3 membrane
4 filling tube
5 mouthpiece
6 direction of flow during filling
7 direction of flow during emptying
8 clamping ring
9 O-ring
10 inner passage
11,12 interlocking structure

1. A valve balloon for inhalers, wherein the valve balloon comprises an elastic, slotted membrane as valve mechanism for filling and emptying the valve balloon.

2. The valve balloon for inhalers according to claim 1, further comprising a mouthpiece positionable between an emptying position wherein the mouthpiece extends through the membrane, and a closed position wherein the mouthpiece does not extend through the membrane, and wherein the membrane pushes the mouthpiece from the emptying position toward the closed position during an automatic closing process.

3. The valve balloon for inhalers according to claim 1, wherein the membrane is secured in a valve housing by means of a lockable clamping ring.

4. The valve balloon for inhalers according to claim 1 wherein the balloon is secured on a clamping ring by an elastic ring, and wherein the clamping ring and the elastic ring are locked inside a valve housing.

5. A valve balloon for inhalers, comprising;
a balloon having an open end; and
a valve mounted over the open end and having a slotted membrane for filling and emptying the balloon.

6. The valve balloon of claim 5, wherein the valve comprises a valve housing defining an inner passage for alternately receiving a filling tube and a mouthpiece, and wherein the slotted membrane is positioned across the inner passage.

7. The valve balloon of claim 6, further comprising a clamping ring having a radially outward surface, the open end of the balloon being positioned over the radially outward surface, and further comprising an O-ring positioned over the bag and the outer surface to hold the bag to the clamping ring.

8. The valve balloon of claim 7, wherein the valve housing has a balloon receiving end, and wherein the clamping ring and the O-ring are positioned in the receiving end whereby the O-ring seals the balloon against the clamping ring.

9. The valve balloon of claim 6, further comprising interlocking structure defined between the mouthpiece and the inner passage for releasably holding the mouthpiece in the inner passage.
